(19) United States
(12) Patent Application Publication
(10) Pub. No.: US 2021/0388809 A1
(43) Pub. Date: Dec. 16, 2021

(54) ACCUMULATOR OVER-PRESSURIZATION IN A HYDROSTATICALLY COMPENSATED COMPRESSED AIR ENERGY STORAGE SYSTEM

(71) Applicant: Hydrostor Inc., Toronto (CA)

(72) Inventors: Davin Young, Toronto (CA); David Brown, Toronto (CA); Cameron Lewis, Toronto (CA); Timothy Ross, Lakewood, CO (US)

(21) Appl. No.: 17/422,616

(22) PCT Filed: Feb. 6, 2020
(86) PCT No.: PCT/CA2020/050153

§ 371 Date: Jul. 13, 2021

Related U.S. Application Data
(60) Provisional application No. 62/802,750, filed on Feb. 8, 2019.

(51) Int. Cl. F03B 13/06; F17C 5/06; B65G 5/00; F28D 20/00

(52) U.S. Cl. CPC F03B 13/06; F17C 5/06; B65G 5/00; F17C 2270/0581; F17C 2221/031; F17C 2223/0153; F17C 2227/0157; F28D 20/00

(57) ABSTRACT

A method of operating a hydrostatically compensated compressed air energy storage system in a first charging mode including conveying the compressed air at a nearly constant first operating pressure which displaces a corresponding volume of compensation liquid from the layer of compensation liquid out of the accumulator, and a second charging mode including conveying additional compressed air into the accumulator while compensation liquid is not displaced from within the accumulator so that the pressure of the layer of compressed air increases to a second operating pressure that is greater than the first operating pressure.

### CROSS-REFERENCE TO RELATED APPLICATIONS

This application claims priority to U.S. Provisional Patent Application Ser. No. 62/802,750, filed Feb. 8, 2019 and entitled A Compressed Gas Energy Storage System, the entirety of this application being incorporated by reference herein.

### FIELD

The present disclosure relates generally to compressed gas energy storage, and more particularly to a compressed gas energy storage system such as, for example, one including a hydrostatically compensated, compressed air energy storage accumulator located underground, and the use thereof.

### INTRODUCTION

Electricity storage is highly sought after, in view of the cost disparities incurred when consuming electrical energy from a power grid during peak usage periods, as compared to low usage periods. The addition of renewable energy sources, being inherently of a discontinuous or intermittent supply nature, increases the demand for affordable electrical energy storage worldwide.

Thus there exists a need for effectively storing the electrical energy produced at a power grid or a renewable source during a non-peak period and providing it to the grid upon demand. Furthermore, to the extent that the infrastructural preparation costs and the environmental impact from implementing such infrastructure are minimized, the utility and desirability of a given solution is enhanced.

Furthermore, as grids transform and operators look to storage in addition to renewables to provide power and remove traditional forms of generation that also provide grid stability, such as voltage support, a storage method that offers inertia based synchronous storage is highly desirable.

### SUMMARY OF THE INVENTION

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

The teachings described herein describe a systems and methods/processes that can help facilitate the over-pressurization of a gas storage accumulator within a hydrostatically compensated compressed air energy storage system.

In accordance with one broad aspect of the teachings herein, a method of operating a hydrostatically compensated compressed air energy storage system is described. The system may include an accumulator having an accumulator interior for containing a layer of compressed air above a layer of compensation liquid, a compensation liquid reservoir spaced apart from the accumulator and connectable in fluid communication with the accumulator via a compensation liquid flow path, a compensation isolation apparatus disposed in the compensation liquid flow path and a gas compressor/expander subsystem in fluid communication with the accumulator interior via an air flow path. The method may then include the steps of:
a) compressing air using the gas compressor/expander subsystem;
b) operating the system in a first charging mode comprising conveying the compressed air at a nearly constant first operating pressure into the accumulator while the compensation isolation apparatus is in an open configuration in which the compensation liquid reservoir is in fluid communication with the layer of compensation liquid within the accumulator, whereby compressed air at the nearly constant first operating pressure is introduced into the layer of compressed air within the accumulator which displaces a corresponding volume of compensation liquid from the layer of compensation liquid out of the accumulator via the liquid flow path thereby maintaining the layer of compressed air at substantially the first operating pressure during the first charging mode;
c) reconfiguring the compensation isolation apparatus into a closed configuration in which fluid communication between the compensation liquid reservoir and the layer of compensation liquid is interrupted;
d) operating the system in a second charging mode comprising conveying additional compressed air into the accumulator while the compensation isolation apparatus is in the closed configuration whereby compensation liquid is not displaced from within the accumulator as compressed air enters the accumulator and the pressure of the layer of compressed air increases to a second operating pressure that is greater than the first operating pressure.

The method may also include operating the system in the first charging mode until the layer of compensation liquid within the accumulator has reached a pre-determined minimum operating height from the lower end of the accumulator.

The pre-determined minimum operating height may be between about Om and about 5m above the lower end of the accumulator.

The method may also include operating the system in the first charging mode until the accumulator is substantially free of compensation liquid and then reconfiguring the compensation isolation apparatus into the closed configuration.

The liquid flow path may include a liquid supply conduit having a lower end that remains submerged within the layer of compensation liquid within the accumulator while the system is operated in the first charging mode.

The lower end of the liquid supply conduit may remain submerged within the layer of compensation liquid within the accumulator while the system is operated in the second charging mode.

The accumulator may be positioned underground at an accumulator depth and the first operating pressure may be substantially equal to the hydrostatic pressure at the accumulator depth when the compensation isolation apparatus is in the open configuration.

The method may also include configuring the system in a storage mode in which the air flow path is interrupted and the compressed air is retained within the accumulator at either the first operating pressure or the second operating pressure.

The system may be configured in the storage mode after the second charging mode and the compressed air is retained within the accumulator at the second operating pressure.

The method may also include the steps of:
e) operating the system in a first discharging mode comprising extracting compressed air from the accumulator via the air flow path while the compensation isolation apparatus is in the closed configuration whereby pressure within the accumulator decreases as the air is extracted and the extracted air drives an expander in the gas compressor/expander subsystem;
f) reconfiguring the compensation isolation apparatus into the open configuration when the pressure within the accumulator reaches the first operating pressure, thereby re-establishing fluid communication between the accumulator and the compensation liquid reservoir;
g) operating the system in a second discharging mode while the compensation isolation apparatus is in the open configuration such that a corresponding volume of compensation liquid flows into the layer of compensation liquid within the accumulator as air is extracted from the accumulator thereby maintaining the interior of the accumulator at the nearly constant first operating pressure during the second discharging mode.

The method may also include continuing the second discharging mode until the layer of compensation liquid within the accumulator has reached a pre-determined maximum height.

The method may also include continuing the second discharging mode until the accumulator is substantially filled with compensation liquid.

The second operating pressure may be between about 120% and about 130% of the first operating pressure.

The compensation liquid may be driven along the liquid flow path by the compressed gas during the first charging mode.

The compensation liquid flows into the accumulator under the force of gravity during the second discharging mode.

In accordance with another broad aspect of the teachings described herein, a hydrostatically compensated compressed air energy storage system may include:
a) an accumulator disposed underground and comprising an interior for containing a layer of compressed air above a layer of compensation liquid;
b) a compressor/expander subsystem in fluid communication with the accumulator interior via an air flow path and configured to selectably convey compressed air into the accumulator and to extract air from the accumulator;
c) a compensation liquid reservoir spaced apart from the accumulator and a compensation liquid flow path extending between the compensation liquid reservoir and the accumulator; and
d) a compensation isolation apparatus provided in the compensation liquid flow path and configurable in an open configuration in which the compensation liquid reservoir is in fluid communication with the accumulator and closed configuration in which fluid communication between the compensation liquid reservoir and the accumulator is interrupted;
   the system may be operable in at least:
i) a first charging mode in which the compensation isolation apparatus is in the open configuration and the gas compressor/expander subsystem is configured to covey compressed air at a nearly constant first operating pressure into the layer of compressed air within the accumulator which then displaces a corresponding volume of compensation liquid from the layer of compensation liquid within the accumulator out of the accumulator via the compensation liquid flow path thereby maintaining the layer of compressed air at substantially the first operating pressure during the first charging mode; and
ii) a second charging mode in which the compensation isolation apparatus is in the closed configuration and the gas compressor/expander subsystem is configured to covey additional compressed air into the accumulator while compensation liquid does not exit the accumulator via the liquid flow path whereby the pressure within the accumulator increases from the first operating pressure to a higher, second operating pressure.

The system may be also operable in a storage mode in which the flow of air through the air flow path is inhibited and the layer of compensation liquid and the layer of compressed gas are stored within the accumulator.

The system may also operable in:
iii) a first discharging mode in which the compensation isolation apparatus is in the closed configuration and the gas compressor/expander subsystem is configured to extract compressed air from the accumulator while compensation liquid does not enter the accumulator via the liquid flow path whereby the pressure within the accumulator decreases from the second operating pressure to the first operating pressure; and
iv) a second discharging mode in which the compensation isolation apparatus is in the open configuration and the gas compressor/expander subsystem is configured to extract additional compressed air from within the accumulator which then enables a corresponding volume of compensation liquid to enter the accumulator thereby maintaining the pressure within the accumulator at the nearly constant first operating pressure during the second discharging mode.

The liquid flow path comprises liquid supply conduit having a lower end that remains submerged within the layer of compensation liquid while the system is operated in the first charging mode and while the system is operated in the second charging mode.

The accumulator may be positioned underground at an accumulator depth and wherein the first operating pressure is substantially equal to the hydrostatic pressure of the layer of compensation liquid at the accumulator depth when the compensation isolation apparatus is in the open configuration.

### BRIEF DESCRIPTION OF THE DRAWINGS

The drawings included herewith are for illustrating various examples of articles, methods, and apparatuses of the teaching of the present specification and are not intended to limit the scope of what is taught in any way.

FIG. 1 is a schematic representation of one example of a hydrostatically compressed gas energy storage system;

FIG. 2 is a schematic representation of a portion of the system of FIG. 1

FIG. 3 is a schematic representation of another example of a hydrostatically compressed gas energy storage system;

FIG. 4A is a schematic representation of another example of a compressed gas energy storage system during a hydrostatically compensated (fixed pressure) charging stage;

FIG. 4B is a schematic representation of another example of a compressed gas energy storage system during a non-compensated (fixed volume) charging stage;

FIG. 4C is a schematic representation of another example of a compressed gas energy storage system during a non-compensated (fixed volume) discharging stage; and

FIG. 4D is a schematic representation of another example of a compressed gas energy storage system during a hydrostatically compensated (fixed pressure) discharging stage.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

Energy produced by some types of energy sources, such as windmills, solar panels and the like may tend to be produced during certain periods (for example when it is windy, or sunny respectively), and not produced during other periods (if it is not windy, or at night, etc.). However, the demand for energy may not always match the production periods, and it may be useful to store the energy for use at a later time. Similarly, it may be helpful to store energy generated using conventional power generators (coal, gas and/or nuclear power plants for example) to help facilitate storage of energy generated during non-peak periods (e.g. periods when electricity supply could be greater than demand and/or when the cost of electricity is relatively high) and allow that energy to be utilized during peak periods (e.g. when the demand for electricity may be equal to or greater than the supply, and/or when the cost of electricity is relatively high).

As described herein, compressing and storing a gas (such as air), using a suitable compressed gas energy storage system, is one way of storing energy for later use. For example, during non-peak times, energy (i.e. electricity) can be used to drive compressors and compress a volume of gas to a desired, relatively high pressure for storage. The gas can then be stored at the relatively high pressure inside any suitable container or vessel, such as a suitable accumulator. To extract the stored energy, the pressurized gas can be released from the accumulator and used to drive any suitable expander apparatus or the like, and ultimately to be used to drive a generator or the like to produce electricity. The amount of energy per unit of storage volume that can be stored in a given compressed gas energy storage system may be related to the pressure at which the gas is compressed/stored, with higher pressure storage generally facilitating a higher energy storage. However, containing gases at relatively high pressures in conventional systems, such as between about 45-150 atm, can require relatively strong, specialized and often relatively costly storage containers/pressure vessels.

When gas is compressed for storage (for example during a charging mode) its temperature tends to increase, and if the gas passes through multiple compression stages its temperature can increase with each stage. Further, some compressors may have a preferred inlet temperature range in which they operate with a desired level of efficiency. Gas that has been compressed in a one compression stage may, in some systems, be heated to a temperature that is above a desired inlet temperature for a subsequent compressions stage. Reducing the temperature of the gas exiting an upstream compressions stage before it reaches a subsequent compression stage may be advantageous.

Similarly, when compressed gas is removed from an accumulator and expanded for electricity generation (for example when in a discharge mode), its temperature tends to decrease, and if the gas passes through multiple expansion stages its temperature can decrease with each stage. Further, some expanders may have a preferred inlet temperature range in which they operate with a desired level of efficiency. Gas that has been expanded in a one expansion stage may, in some systems, be cooled to a temperature that is below a desired inlet temperature for a subsequent expansion stage. Increasing the temperature of the gas exiting an upstream expansion stage before it reaches a subsequent expansion stage may be advantageous.

Optionally, heat that is removed/extracted from the gas exiting one or more compression stages when the system is in a charging mode of the system can be stored in a suitable thermal storage subsystem, and preferably that heat/thermal energy can then be re-introduced into the gas that is removed from the accumulator and is passing through suitable expansion stages during the discharge mode. This may help improve the overall efficiency of a compressed gas energy storage system. This may also help reduce and/or eliminate the need for heat sinks/sources or other apparatuses to dissipate heat when in the charging mode and/or supply new heat when in the discharge mode.

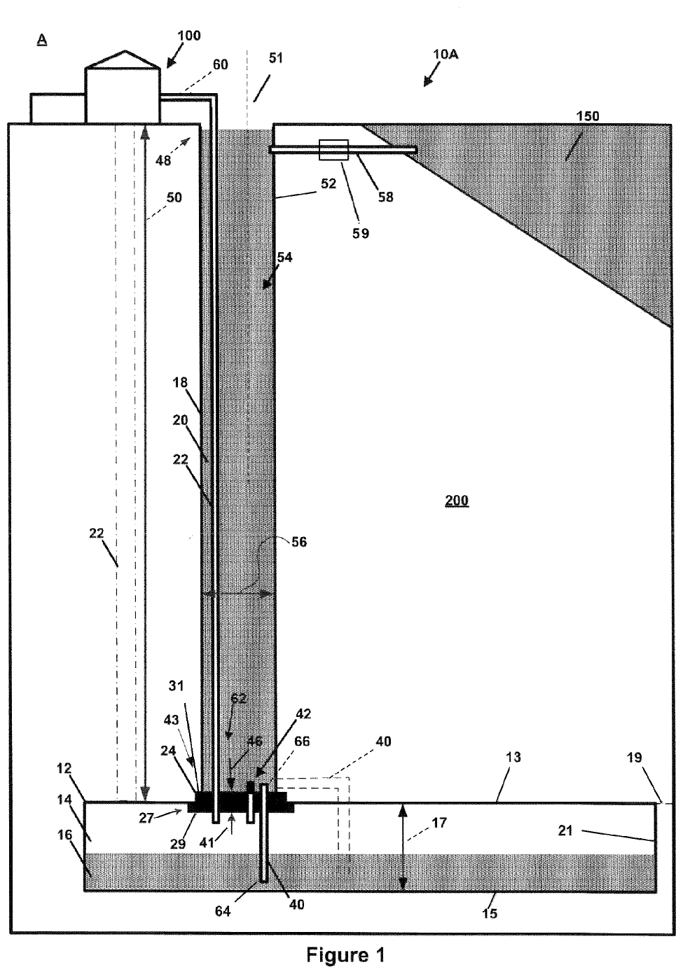

Referring to FIG. 1 one example of a hydrostatically compensated compressed gas energy storage system 10A, that can be used to compress, store and release a gas, includes an accumulator 12 that is located underground (although in another embodiment the accumulator may be located above ground). In this example, the accumulator 12 serves as a chamber for holding both compressed gas and a liquid (such as water) and can include any suitable type of pressure vessel or tank, or as in this example can be an underground cave or chamber that is within ground 200. In this embodiment, accumulator 12 is lined, for example using concrete, metal, plastic and combinations thereof or the like, to help make it substantially gas and/or liquid impermeable so as to help to prevent unwanted egress of gas or liquid from within the interior 23. In another embodiment, the accumulator is preferably impermeable to gas and or liquid without requiring a lining.

The accumulator 12 may have any suitable configuration, and in this example, includes an upper wall 13 and an opposing lower wall 15 that are separated from each other by an accumulator height 17. The upper and lower walls 13 and 15 may be of any suitable configuration, including curved, arcuate, angled, and the like, and in the illustrated example are shown as generally planar surfaces, that are generally parallel to a horizontal reference plane 19. The accumulator 12 also has an accumulator width (not shown—measured into the page as illustrated in FIG. 1). The upper and lower walls 13 and 15, along with one or more sidewalls 21 at least partially define an interior 23 of the accumulator 12, that has an accumulator volume.

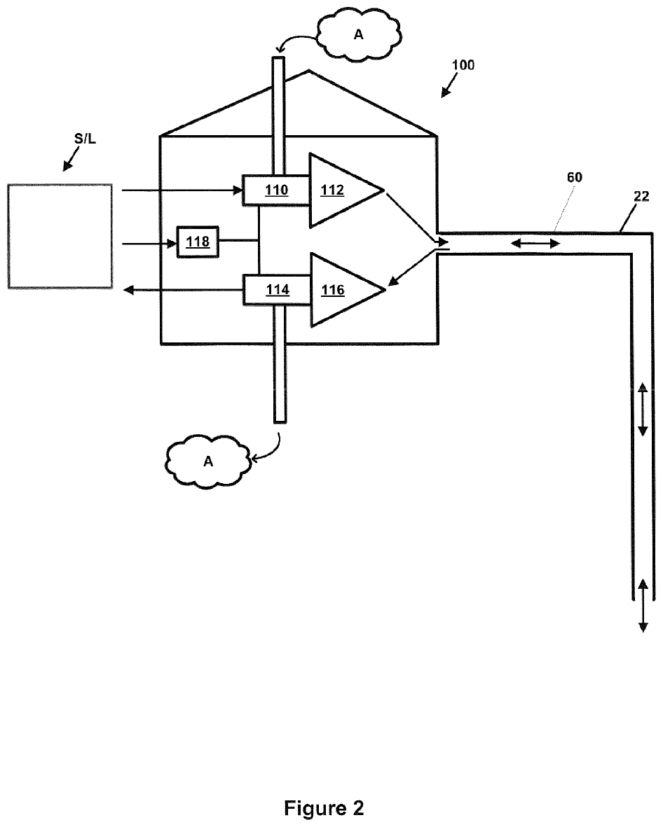

The accumulator 12 in a given embodiment of the system 10A can be sized based on a variety of factors (e.g. the quantity of gas to be stored, the available space in a given location, etc.) and may, in some examples may be between about 1,000 m³ and about 2,000,000 m³ or more. For example, in this embodiment the accumulator 12 contains a layer of stored compressed gas 14 atop a layer of liquid 16 when in use, and its volume (and thus capacity) can be selected based on the quantity of gas 14 to be stored, the duration of storage required for system 10A, and other suitable factors which may be related to the capacity or other features of a suitable power source and/or power load (see power source/load S/L in FIG. 2) with which the system 10A is to be associated. The power source/load S/L may be, in some examples, a power grid, a power source (including renewable and optionally non-renewable sources), a large industrial load and the like. Furthermore, the power source and power load may be completely independent of each other (e.g. the power source 25 may be a renewable source, and the power load may be the grid).

Preferably, the accumulator 12 may be positioned below ground or underwater, but alternatively may be at least partially above ground. Positioning the accumulator 12 within the ground 200, as shown, may allow the weight of the ground/soil to help backstop/buttress the walls 13, 15 and 21 of the accumulator 12, and help resist any outwardly acting forces that are exerted on the walls 13, 15 and 21 of the interior 23 of the accumulator. Its depth in the ground may be established according to the pressures at which the compression/expansion equipment to be used is most efficiently operated, the geology in the surrounding area and the like.

The gas that is to be compressed and stored in the accumulator 12 may be any suitable gas, including, but not limited to, air, nitrogen, noble gases and combinations thereof and the like. Using air may be preferable in some embodiments as a desired quantity of air may be drawn into the system from the surrounding, ambient environment and gas/air that is released from within the accumulator 12 can similarly be vented to the ambient environment, optionally without requiring further treatment. The liquid that is to be used as the liquid layer 16 in the accumulator 12 may be any suitable liquid, including, but not limited to, water (municipal water, ground water, rain water, etc.), salt water, brine and combinations thereof and the like. Using water may be preferable in some embodiments as a desired quantity of water may be sourced easily, and any liquid which may escape from the system can enter the groundwater system without environmental concerns. In this embodiment, the compressed gas 14 is compressed atmospheric air, and the liquid is water.

Optionally, to help provide access to the interior of the accumulator 12, for example for use during construction of the accumulator and/or to permit access for inspection and/or maintenance, the accumulator 12 may include at least one opening that can be sealed in a generally air/gas tight manner when the system 10A is in use. In this example, the accumulator 12 includes a primary opening 27 that is provided in the upper wall 13. The primary opening 27 may be any suitable size and may have a cross-sectional area (taken in the plane 19) that is adequate based on the specific requirements of a given embodiment of the system 10A. In one embodiment the cross-sectional area is between about 0.75 m2 and about 80 m2 but may be larger or smaller in a given embodiment.

When the system 10A is in use, the primary opening 27 may be sealed using any suitable type of partition that can function as a suitable sealing member. In the embodiment of FIG. 1, the system 10A includes a partition in the form of a bulkhead 24 that covers the primary opening 27. Some examples of suitable partitions are described in PCT/CA2018/050112 and PCT/CA2018/050282, which are incorporated herein by reference.

When the bulkhead 24 is in place, as shown in FIG. 1, it can be secured to, and preferably sealed with the accumulator wall, in this embodiment upper wall 13, using any suitable mechanism to help seal and enclose the interior 23. In other embodiments, the bulkhead 24 may have a different, suitable configuration.

The bulkhead 24 may be manufactured in situ, or may be manufactured offsite, and may be made of any suitable material, including, concrete, metal, plastics, composites and the like. In the illustrated embodiment, the bulkhead 24 is assembled in situ at the interface between a shaft 18 and the accumulator 12 of multiple pieces of reinforced concrete. In this embodiment the shaft 18 is illustrated schematically as a generally linear, vertical column. Alternatively, the shaft 18 may be a generally linear inclined shaft or preferably may be a curved and/or generally spiral/helical type configuration and which may be referred to as a shaft or generally as a decline. Some embodiments may include a generally spiralling configured decline that winds from an upper end to a lower end and can have an analogous function and attributes as the vertical shaft 18 of FIG. 1 despite having a different geometrical configuration. Discussions of the shaft/decline 18 and its purposes in one embodiment can be applied to other embodiments described herein.

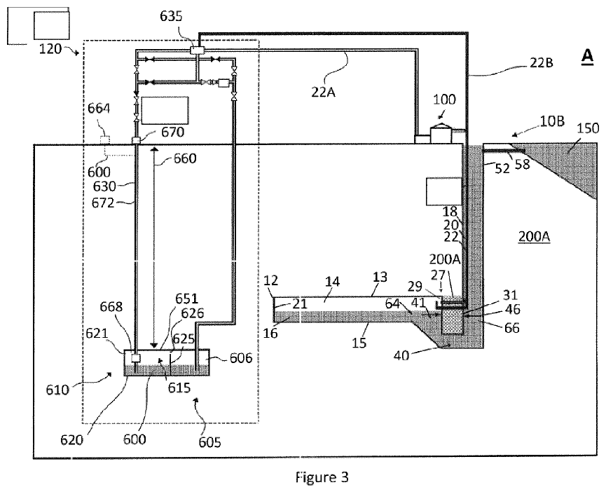

In the embodiment of FIG. 1, the primary opening 27 is provided in the upper surface 13 of the accumulator 12. Alternatively, in other embodiments the primary opening 27 and any associated partition may be provided in different portions of the accumulator 12, including, for example, on a sidewall (such as sidewall 21 as shown in FIG. 3), in a lower surface (such as lower surface 15) or other suitable location. The location of the primary opening 27, and the associated partition, can be selected based on a variety of factors including, for example, the soil and underground conditions, the availability of existing structures (e.g. if the system 10A is being retrofit into some existing spaces, such as mines, quarries, storage facilities and the like), operating pressures, shaft configurations and the like. For example, some aspects of the systems 10A described herein may be retrofit into pre-existing underground chambers, which may have been constructed with openings in their sidewalls, floors and the like. Utilizing some of these existing formations may help facilitate construction and/or retrofit of the chambers used in the system and may reduce or eliminate the need to form additional openings in the upper surfaces of the chambers. Reducing the total number of openings in the accumulator may help facilitate sealing and may help reduce the chances of leaks and the like. In other embodiments, the components of the systems described herein may be purpose-built for the described purposes and may be configured in manner that helps facilitate both construction and operation of the systems.

When the primary opening 27 extends along the sidewall 21 of the accumulator 12 as shown in the embodiment of FIG. 3, it may be positioned such that is contacted by only the gas layer 14 (i.e. toward the top of the accumulator 12), contacted by only the liquid layer 16 (i.e. submerged within the liquid layer 16 and toward the bottom of the accumulator) and/or by a combination of both the gas layer 14 and the liquid layer 16 (i.e. partially submerged and partially non-submerged in the liquid). The specific position of the free surface of the liquid layer 16 (i.e. the interface between the liquid layer 16 and the gas layer 14) may change while the system 10 is in use as gas is forced into (causing the liquid layer to drop) and/or withdrawn from the accumulator (allowing the liquid level to rise).

When the accumulator 12 is in use, at least one of the pressurized gas layer 14 and the liquid layer 16 may contact and exert pressure on the inner-surface 29 of the bulkhead 24, which will result in a generally outwardly, (upwardly in this embodiment) acting internal accumulator force, represented by arrow 41 in FIG. 1, acting on the bulkhead 24. The magnitude of the internal accumulator force 41 acting on the partition may be at least partially dependent on the pressure of the gas 14 and the cross-sectional area (taken in plane 19) of the lower surface 29. For a given lower surface 29 area, the magnitude of the internal accumulator force 41 may vary generally proportionally with the pressure of the gas 14.

In some embodiments, for example if the compressed gas energy storage system is not hydrostatically compensated, the partition may be configured to resist substantially the entire internal accumulator force 41 and/or may be reinforced with the ground 200 or other suitable structures. Alternatively, an inwardly, (downwardly in this embodiment) acting force can be applied to the upper surface 31 of the bulkhead 24 to help at least partially offset and/or counterbalance the internal accumulator force 41. Applying a counter force of this nature may help reduce the net force acting on the bulkhead 24 while the system 10 is in use. This may help facilitate the use of a bulkhead 24 with lower pressure tolerances than would be required if the bulkhead 24 had to resist the entire magnitude of the internal accumulator force 41. This may allow the bulkhead 24 be relatively smaller, lighter and less costly. This arrangement may also help reduce the chances of the bulkhead 24 failing while the system 10 is in use. Optionally, a suitable counter force may be created by subjecting the upper surface 31 to a pressurized environment, such as a pressurized gas or liquid or the distributed weight from a pile of solid material that is in contact with the upper surface 31, and calibrating the pressure acting on the upper surface 31 (based on the relative cross-sectional area of the upper surface 31 and the pressure acting on the lower surface 29) so that the resulting counter force, shown by arrow 46 in FIG. 1, has a desirable magnitude. In some configurations, the magnitude of the counter force 46 may be between about 80% and about 99% of the internal accumulator force 41 and may optionally be between 5 about 90% and about 97% and may be about equal to the magnitude of the internal accumulator force 41.

In the present embodiment, the system 10 includes a shaft 18 that is configured so its lower end 43 is in communication with the opening 27 of the accumulator 12, and its upper end 48 that is spaced apart from the lower end 43 by a shaft height 50. At least one sidewall 52 extends from the lower end 43 to the upper end 48, and at least partially defines a shaft interior 54 having a volume. In this embodiment, the shaft 18 is generally linear and extends along a generally vertical shaft axis 51, but may have other configurations, such as a linear, curved, or helical decline, in other embodiments. The upper end 48 of the shaft 18 may be open to the atmosphere A, as shown, or may be capped, enclosed or otherwise sealed. In this embodiment, shaft 18 is generally cylindrical with a diameter 56 of about 3 metres, and in other embodiments the diameter 56 may be between about 2m and about 15m or more, or may be between about 5m and 12m, or between about 2m and about 5m. In such arrangements, the interior 52 of the shaft 18 may be able to accommodate about 1,000-150,000 m³ of water. While the schematics included show only one shaft 18, multiple smaller diameter shafts may be used in place of one larger diameter shaft.

In this arrangement, the bulkhead 24 is positioned at the interface between the shaft 18 and the accumulator 12, and the upper surface 31 (or at least a portion thereof) closes and seals the lower end 43 of the shaft 18. Preferably, the other boundaries of the shaft 18 (e.g. the sidewall 52) are generally liquid impermeable, such that the interior 54 can be filled with, and can generally retain a quantity of a liquid, such as water 20. A water supply/replenishment conduit 58 can provide fluid communication between the interior 54 of the shaft 18 and a water source/sink 150 to allow water to flow into or out of the interior of the shaft 18 as required when the system 10 is in operational modes. Optionally, a flow control apparatus 59 (as shown in FIG. 1) may be provided in the water supply/replenishment conduit 58. The flow control apparatus 59 may include a valve, sluice gate, controllable pump or other suitable mechanism. The flow control apparatus 59 can be open while the system 10 is in operational modes to help facilitate the desired flow of water between the shaft 18 and the water source/sink 150. For the purposes of the teachings described herein a liquid flow path refers to the fluid connection between the reservoir 150 and the layer of water 16 within the accumulator 12 and can include a variety of portions/aspects, including the supply/replenishment conduit 58, the shaft 18, the liquid supply conduit 40 and any other associated hardware, etc.

Optionally, the flow control apparatus 59 can be closed to fluidly isolate the shaft 18 and the water source/sink 150 if desired. For example, the flow control apparatus 59 may be closed to help facilitate draining the interior 54 of the shaft 18 for inspection, maintenance or the like. Optionally, the flow control valve 59 can also be closed to fluidly isolate the shaft 18 and the water source/sink 150 during operation as described in greater detail herein. This may help facilitate charging the cavern to a higher pressure than could be achieved if the valve were to remain open.

The water source/sink 150 may be of any suitable nature, and may include, for example a connection to a municipal water supply or reservoir, a purposely built reservoir, a storage tank, a water tower, and/or a natural body of water such as a lake, river or ocean, groundwater, or an aquifer. In the illustrated example, the water source/sink 150 is illustrated as a lake. Allowing water to flow through the conduit 58 may help ensure that a sufficient quantity of water 20 may be maintained with shaft 18 and that excess water 20 can be drained from shaft 18. The conduit 58 may be connected to the shaft 18 at any suitable location, and preferably is connected toward the upper end 48. Preferably, the conduit 58 can be positioned and configured such that water will flow from the source/sink 150 to the shaft 18 via gravity, and need not include external, powered pumps or other conveying apparatus. Although the conduit 58 is depicted in the figures as horizontal, it may be non-horizontal.

In this example, the water 20 in the shaft 18 bears against the outside of bulkhead 24 and is thereby supported atop bulkhead 24. The amount of pressure acting on the upper surface 31 of the bulkhead 24 in this example will vary with the volume of water 20 that is supported, which for a given diameter 56 will vary with the height 50 of the water column.

The layer of stored compressed air 14 underlying bulkhead 24 serves, along with the technique by which bulkhead 24 is stably affixed to the surrounding in the ground, in one alternative to surrounding stone in the ground at the interface between accumulator 12 and shaft 18, to support bulkhead 24 and the quantity of liquid contained within shaft 18.

Preferably, as will be described, the pressure at which the quantity of water 20 bears against bulkhead 24 can be maintained so that magnitude of the counter force 46 is equal, or nearly equal, to the magnitude of the internal accumulator force 41 exerted by the compressed gas in compressed gas layer 14 stored in accumulator 12 for at least a fraction of the time the system is in operation. In the illustrated embodiment, system 10 is operated so as to maintain a pressure differential (i.e. the difference between gas pressure inside the accumulator 12 and the hydrostatic pressure at the lower end 43 of the shaft 18) below a threshold amount—an amount preferably between 0 and 4 Bar, such as 2 Bar—the resulting net force acting on the bulkhead 24. Maintaining the net pressure differential, and the related net force magnitude, below a threshold net pressure differential limit may help reduce the need for the bulkhead 24 to be very large and highly-reinforced, and accordingly relatively expensive. In alternative embodiments, using a relatively stronger bulkhead 24 and/or installation technique for affixing the bulkhead 24 to the accumulator 12 may help withstand relatively higher pressure and net pressure differential, but may be more expensive to construct and install, all other things being equal. Furthermore, the height 17 of the accumulator 12 may be important to the pressure differential: if the height 17 is about 10 metres, then the maximum upward pressure on the bulkhead 24 will be 1 Bar higher than the downward pressure on the bulkhead 24 from the water 20 in shaft 18. The maximum pressure differential that is experienced by bulkhead 24 may increase by about 0.1 bar for every meter that the height 17 of the accumulator 12 is increased.

Each of shaft 18 and accumulator 12 may be formed in ground 200 using techniques similar to those used for producing mineshafts and other underground structures.

To help maintain substantially equal outward and inward forces 41 and 46 respectively on the bulkhead 24, the system 10 may be utilized to help maintain a desired differential in accumulator and shaft pressures that is below a threshold amount. These pressures may be controlled by adding or removing gas from the compressed gas layer 14 in accumulator 12 using any suitable compressor/expander subsystem 100, and in turn conveying water between the liquid layer 16 in accumulator 12 and the water 20 in shaft 18.

In this embodiment, the system 10A includes a gas flow path that provides fluid communication between the compressor/expander subsystem 100 and the accumulator 12. The gas flow path may include any suitable number of conduits, passages, hoses, pipes and the like and any suitable equipment may be provided in (i.e. in air flow communication with) the gas flow path, including, compressors, extractors, heat exchangers, valves, sensors, flow meters and the like. Referring to the example of FIG. 1, in this example the gas flow path includes a gas conduit 22 that is provided to convey compressed air between the compressed gas layer 14 and the compressor/expander subsystem 100, which can convert the potential energy of compressed air to and from electricity. Similarly, a liquid supply conduit 40 is configured to convey water between the liquid layer 16 and the water 20 in shaft 18. Each conduit 22 and 40 may be formed from any suitable material, including metal, the surrounding rock, plastic and the like.

In this example, the gas conduit 22 has an upper end 60 that is connected to the compressor/expander subsystem 100, and a lower end 62 that is in communication with the compressed gas layer 14. The gas conduit 22 is, in this example, positioned inside and extends within the shaft 18, and passes through the bulkhead 24 to reach the compressed gas layer 14. Positioning the gas conduit 22 within the shaft 18 may eliminate the need to bore a second shaft and/or access path from the surface to the accumulator 12. The positioning in the current embodiment may also leave the gas conduit 22 generally exposed for inspection and maintenance, for example by using a diver or robot that can travel through the water 20 within the shaft 18 and/or by draining some or all of the water from the shaft 18. Alternatively, as shown using dashed lines in FIG. 1 and in the embodiment of FIG. 3, the gas conduit 22 may be external the shaft 18. Positioning the gas conduit 22 outside the shaft 18 may help facilitate the re-use of shafts used for construction, may help facilitate the remote placement of the compressor/expander subsystem 100 (i.e. it need not be proximate the shaft 18) and may not require the exterior of the gas conduit 22 (or its housing) to be submerged in water. This may also eliminate the need for the gas conduit 22 to pass through the partition that separates the accumulator 12 from the shaft 18.

The liquid supply conduit 40 is, in this example, configured with a lower end 64 that is submerged in the water layer 16 while the system 10 is in use and a remote upper end 66 that is in communication with the interior 54 of the shaft 18. In this configuration, the liquid supply conduit 40 can facilitate the exchange of liquid between the liquid layer 16 and the water 20 in the shaft 18. As illustrated in FIG. 1, the liquid supply conduit 40 can pass through the bulkhead 24 (as described herein), or alternatively, as shown using dashed lines, may be configured to provide communication between the liquid layer 16 and the water 20, but not pass through the bulkhead 24.

In this arrangement, as more gas is transferred into the gas layer 14 during an accumulation cycle or charging mode water in the water layer 16 can be displaced and forced upwards through the liquid supply conduit 40 into shaft 18 against the hydrostatic pressure of the water 20 in the shaft 18. More particularly, water can preferably freely flow from the bottom of accumulator 12 and into shaft 18, and ultimately may be exchanged with the source/sink 150 of water, via a replenishment conduit 58. This displacement of the water layer 16 that is used to compensate for the changes in the amount of gas that is in the accumulator can help vary the unsubmerged volume of the accumulator in response to changes in gas volume (i.e. by changing the height of the layer of water, which can help maintain a relatively constant pressure within the accumulator 12 while the quantity of gas changes. Alternatively, any suitable type of flow limiting or regulating device (such as a pump, valve, orifice plate and the like) can be provided in the water conduit 40. When gas is removed from the gas layer 14, water can be forced from the shaft 18, through the water conduit 40, to refill the water layer 16. The flow through the replenishment conduit 58 can help ensure that a desired quantity of water 20 may be maintained within shaft 18 as water is forced into and out of the water layer 16, as excess water 20 can be drained from and make-up water can be supplied to the shaft 18. This arrangement can allow the pressures in the accumulator 12 and shaft 18 to at least partially, automatically re-balance as gas is forced into and released from the accumulator 12.

Preferably, the lower end 64 of the liquid supply conduit 40 is positioned so that it is and generally remains submerged in the liquid layer 16 while the system 10 is in operational modes and is not in direct communication with the gas layer 14. In the illustrated example, the lower wall 15 is planar and is generally horizontal (parallel to plane 19, or optionally arranged to have a maximum grade of between about 0.01% to about 1%, and optionally between about 0.5% and about 1%, from horizontal), and the lower end 64 of the liquid supply conduit 40 is placed close to the lower wall 15. If the lower wall 15 is not flat or not generally horizontal, the lower end 64 of the liquid supply conduit 40 is preferably located in a low point of the accumulator 12 to help reduce the chances of the lower end 64 being exposed to the gas layer 14.

Similarly, to help facilitate extraction of gas from the gas layer, the lower end 62 of the gas conduit 22 is preferably located close to the upper wall 13, or if the upper wall 13 is not flat or generally horizontal at a high-point in the interior 23 of the accumulator 12. This may help reduce material trapping of any gas in the accumulator 12. For example, if the upper wall 13 were oriented on a grade, the point at which gas conduit 22 interfaces with the gas layer (i.e. its lower end 62) should be at a high point in the accumulator 12, to help avoid significant trapping of gas.

In the embodiment of FIG. 1, the partition includes a fabricated bulkhead 24 that is positioned to cover, and optionally seal the primary opening 27 in the accumulator perimeter. Alternatively, in other embodiments, the partition may be at least partially formed from natural materials, such as rock and the like. For example, a suitable partition may be formed by leaving and/or shaping portions of naturally occurring rock to help form at least a portion of the pressure boundary between the interior of the accumulator and the shaft. Such formations may be treated, coated or otherwise modified to help ensure they are sufficiently gas impermeable to be able to withstand the desired operating pressure differentials between the accumulator interior and the shaft. This may be done, in some embodiments, by selectively excavating the shaft 18 and accumulator 12 such that a portion of the surrounding rock is generally undisturbed during the excavation and construction of the shaft 18 and accumulator 12. Alternatively, rock or other such material may be re-introduced into a suitable location within the accumulator 12 and/or shaft 18 after having been previously excavated. This may help reduce the need to manufacture a separate bulkhead and install it within the system 10. In arrangements of this nature, the primary opening 27 may be formed as an opening in a sidewall 21 of the accumulator 12, or alternatively one side of the accumulator 12 may be substantially open such that the primary opening 27 extends substantially the entire accumulator height 17, and forms substantially one entire side of the accumulator 12.

When the accumulator 12 is in use, at least one of the pressurized gas layer 14 and the liquid layer 16, or both, may contact and exert pressure on the inner-surface 29 of the bulkhead 24, which will result in a generally outwardly, (upwardly in this embodiment) acting internal accumulator force, represented by arrow 41 in FIG. 1, acting on the bulkhead 24. The magnitude of the internal accumulator force 41 is dependent on the pressure of the gas 14 and the cross-sectional area (taken in plane 19) of the lower surface 29. For a given lower surface 29 area, the magnitude of the internal accumulator force 41 may vary generally proportionally with the pressure of the gas 14.

Preferably, an inwardly, (downwardly in this embodiment) acting force can be applied to the upper surface 31 of the bulkhead 24 to help offset and/or counterbalance the internal accumulator force 41. Applying a counter force of this nature may help reduce the net force acting on the bulkhead 24 while the system 10 is in use. This may help facilitate the use of a bulkhead 24 with lower pressure tolerances than would be required if the bulkhead 24 had to resist the entire magnitude of the internal accumulator force 41. This may allow the bulkhead 24 be relatively smaller, lighter and less costly. This arrangement may also help reduce the chances of the bulkhead 24 failing while the system 10 is in use. Optionally, a suitable counter force may be created by subjecting the upper surface 31 to a pressurized environment, such as a pressurized gas or liquid that is in contact with the upper surface 31, and calibrating the pressure acting on the upper surface 31 (based on the relative cross-sectional area of the upper surface 31 and the pressure acting on the lower surface 29) so that the resulting counter force, shown by arrow 46 in FIG. 1, has a desirable magnitude. In some configurations, the magnitude of the counter force 46 may be between about 80% and about 99% of the internal accumulator force 41 and may optionally be between about 90% and about 97% and may be about equal to the magnitude of the internal accumulator force 41.

In the present embodiment, the system 10 includes a shaft 18 having a lower end 43 that is in communication with the opening 27 in the upper wall 13 of the accumulator 12, and an upper end 48 that is spaced apart from the lower end 43 by a shaft height 50. At least one sidewall 52 extends from the lower end 43 to the upper end 48, and at least partially defines a shaft interior 54 having a volume. In this embodiment, the shaft 18 is generally linear and extends along a generally vertical shaft axis 51, but may have other configurations, such as a linear or helical decline, in other embodiments. The upper end 48 of the shaft 18 may be open to the atmosphere A, as shown, or may be capped, enclosed or otherwise sealed. In this embodiment, shaft 18 is generally cylindrical with a diameter 56 of about 3 metres, and in other embodiments the diameter 56 may be between about 2m and about 15m or more, or may be between about 5m and 12m, or between about 2m and about 5m. In such arrangements, the interior 52 of the shaft 18 may be able to accommodate about 1,000-150,000 m³ of water. In other embodiments the shaft need not be cylindrical and may have other cross-sectional geometries with the same hydraulic diameter.

In this arrangement, the bulkhead 24 is positioned at the interface between the shaft 18 and the accumulator 12, and the upper surface 31 (or at least a portion thereof) closes and seals the lower end 43 of the shaft 18. Preferably, the other boundaries of the shaft 18 (e.g. the sidewall 52) are generally liquid impermeable, such that the interior 54 can be filled with, and can generally retain a quantity of a liquid, such as water 20. A water supply/replenishment conduit 58 can provide fluid communication between the interior 54 of the shaft 18 and a water source/sink 150 to allow water to flow into or out of the interior of the shaft 18 as required when the system 10 is in use. Optionally, a flow control valve 59 (as shown in FIG. 1) may be provided in the water supply/replenishment conduit 58. The flow control valve 59 can be open while the system 10 is in use to help facilitate the desired flow of water between the shaft 18 and the water source/sink 150. Optionally, the flow control valve 59 can be closed to fluidly isolate the shaft 18 and the water source/sink 150 if desired. For example, the flow control valve 59 may be closed to help facilitate draining the interior 54 of the shaft 18 for inspection, maintenance or the like. Optionally, the flow control valve 59 can also be closed to fluidly isolate the shaft 18 and the water source/sink 150 during operation. This may help facilitate charging the cavern to a higher pressure than could be achieved if the valve were to remain open, as explained in greater detail herein.

The water source/sink 150 may be of any suitable nature, and may include, for example a connection to a municipal water supply or reservoir, a purposely built reservoir, a storage tank, a water tower, and/or a natural body of water such as a lake, river or ocean, groundwater, or an aquifer. In the illustrated example, the water source/sink 150 is illustrated as a lake. Allowing water to flow through the conduit 58 may help ensure that a sufficient quantity of water 20 may be maintained with shaft 18 and that excess water 20 can be drained from shaft 18. The conduit 58 may be connected to the shaft 18 at any suitable location, and preferably is connected toward the upper end 48. Preferably, the conduit 58 can be positioned and configured such that water will flow from the source/sink 150 to the shaft 18 via gravity, and need not include external, powered pumps or other conveying apparatus. Although the conduit 58 is depicted in the figures as horizontal, it may be non-horizontal.

In this example, the water 20 in the shaft 18 bears against the outside of bulkhead 24 and is thereby supported atop bulkhead 24. The amount of pressure acting on the upper surface 31 of the bulkhead 24 in this example will vary with the volume of water 20 that is supported, which for a given diameter 56 will vary with the height 50 of the water column. In this arrangement, the magnitude of the counter force 46 can then be generally proportional to the amount of water 20 held in the shaft 18. To increase the magnitude of the counter force 46, more water 20 can be added. To reduce the magnitude of the counter force 46, water 20 can be removed from the interior 54.

FIG. 2 is a schematic view of components of one example of a compressor/expander subsystem 100 for the compressed gas energy storage system 10 described herein. In this example, the compressor/expander subsystem 100 includes a compressor 112 of single or multiple stages, driven by a motor 110 that is powered, in one alternative, using electricity from a power grid or by a renewable power source or the like, and optionally controlled using a suitable controller 118. Compressor 112 is driven by motor 110 during an accumulation stage of operation, and draws in atmospheric air A, compresses the air, and forces it down into gas conduit 22 for storage in accumulator 12 (via thermal storage subsystem 120 (see FIG. 1 for example) in embodiments including same). Compressor/expander subsystem 100 also includes an expander 116 driven by compressed air exiting from gas conduit 22 during an expansion stage of operation and, in turn, driving generator 114 to generate electricity. After driving the expander 116, the expanded air is conveyed for exit to the atmosphere A. While shown as separate apparatuses, the compressor 112 and expander 116 may be part of a common apparatus, as can a hybrid motor/generator apparatus. Optionally, the motor and generator may be provided in a single machine.

Air entering or leaving compressor/expander subsystem 100 may be conditioned prior to its entry or exit. For example, air exiting or entering compressor/expander subsystem 100 may be heated and/or cooled to reduce undesirable environmental impacts or to cause the air to be at a temperature suited for an efficient operating range of a particular stage of compressor 112 or expander 116. For example, air (or other gas being used) exiting a given stage of a compressor 112 may be cooled prior to entering a subsequent compressor stage and/or the accumulator 12, and/or the air may be warmed prior to entering a given stage of an expander 116 and may be warmed between expander stages in systems that include two or more expander stages arranged in series.

Controller 118 operates compressor/expander subsystem 100 so as to switch between accumulation and expansion stages as required, including operating valves for preventing or enabling release of compressed air from gas conduit 22 on demand.

Optionally, the system 10A may include a thermal storage subsystem 120 (illustrated schematically in FIG. 1) that is configured to transfer heat/thermal energy out of and preferably also into the gas flowing through the gas flow path between the accumulator and the compressor/expander subsystem 100. Preferably, the thermal storage subsystem 120 is configured to extract thermal energy from the gas exiting at least one of the one or more compression stages in a given compressor/expander subsystem 100, and preferably being configured to extract heat from the gas exiting each compression stage 112. The extracted thermal energy can then be stored for a period of time, and then reintroduced into the gas as it is removed from the accumulator 12 and passed through one or more expanders 116.

The thermal storage subsystem 120 may include any suitable type of thermal storage apparatus, including, for example latent and/or sensible storage apparatuses. The thermal storage apparatus(es) may be configured as single stage, two stage and/or multiple stage storage apparatus(es). Similarly, the thermal storage subsystem 120 may include one or more heat exchangers (to transfer thermal energy into and/or out of the thermal storage subsystem 120) and one or more storage apparatuses (including, for example storage reservoirs for holding thermal storage fluids and the like). Any of the thermal storage apparatuses may either be separated from or proximate to their associated heat exchanger and may also incorporate the associated heat exchanger in a single compound apparatus (i.e. in which the heat exchanger is integrated within the storage reservoir). Preferably, the heat exchangers utilized in the thermal storage subsystem 120 are provided in the gas flow path and are operable to transfer thermal energy between the compressed gas travelling through the gas flow path and the thermal storage media (which may be a solid, liquid or gas).

The exchangers may be any suitable type of heat exchanger for a given type of thermal storage media, and may include, for example, indirect heat exchangers or direct heat exchangers. The preferable type of heat exchanger for a given system may depend on a variety of factors and/or elements of the system. For example, a direct heat exchanger (i.e. that permits direct contact between the two sides/streams of the exchanger) may help facilitate for more conductivity between the compressed gas and thermal storage media and may, under some circumstances, be relatively more efficient in transferring thermal energy between the two than a comparable indirect heat exchanger. A direct heat exchanger may be preferred when using solid thermal storage media, such as rocks or gravel and may also be used in combination with a thermal storage liquid if both the gas and liquid streams are maintained under suitable conditions to help maintain the thermal storage liquid in its liquid state, and to avoid boiling and/or mixing of the gas stream and liquid stream.

An indirect heat exchanger may be preferable in systems in which the compressed gas is to be kept separate from the thermal storage media, such as if the thermal storage media needs to be kept under specific conditions, including pressure and/or if both streams in the heat exchanger are fluid such that there would be a mixing of the thermal storage media and the compressed system gas within the heat exchanger.

In general, as gas is compressed by the compressor/expander subsystem 100 when in the charging mode and is conveyed for storage towards accumulator 12, the heat of the compressed gas can be drawn out of the compressed gas and into the thermal storage subsystem 120 for sensible and/or latent heat storage. In this way, at least a portion of the heat energy is saved for future use instead of, for example being leached out of the compressed gas into water 20 or in the liquid layer 16, and accordingly substantially lost (i.e. non-recoverable by the system 10).

Similarly, when in a discharge mode as gas is released from accumulator 12 towards compressor/expander subsystem 100 it can optionally be passed through thermal storage subsystem 120 to re-absorb at least some of the stored heat energy on its way to the expander stage of the compressor/expander subsystem 100. Advantageously, the compressed gas, accordingly heated, can reach the compressor/expander subsystem 100 at a desired temperature (an expansion temperature—that is preferably warmer/higher than the accumulator temperature), and may be within about 10° C. and about 60° C. of the exit temperature in some examples, that may help enable the expander to operate within its relatively efficient operating temperature range(s), rather than having to operate outside of the range with cooler compressed gas.

In embodiments of the thermal storage subsystem 120 employing sensible heat storage, pressurized water, or any other suitable thermal storage fluid/liquid and/or coolant, may be employed as the sensible thermal storage medium. Optionally, such systems may be configured so that the thermal storage liquid remains liquid while the system 10A is in use and does not undergo a meaningful phase change (i.e. does not boil to become a gas). This may help reduce the loss of thermal energy via the phase change process. For example, such thermal storage liquids (e.g. water) may be pressurized and maintained at an operating pressure that is sufficient to generally keep the water in its liquid phase during the heat absorption process as its temperature rises. That is, the reservoir and/or conduits containing a thermal storage liquid can be pressurized to a pressure that is greater than atmospheric pressure, and optionally may be at least between about 10 and 60 bar, and may be between about 30 and 45 bar, and between about 20 and 26 bar, so that the thermal storage liquid can be heated to a temperature that is greater than its boiling temperature at atmospheric pressure.

In the system 10A, the storage pressure within the accumulator can, in some embodiments, be generally limited to a pressure that is about equal to the hydrostatic pressure of the compensation water in the water layer 16, which may be related to the shaft height 50. For example, as gas is supplied into the accumulator 12 it will displace water from the water layer 16 and the pressure that can accumulate within the gas layer 14 is generally balanced by the opposing pressure of the compensation water—i.e. the pressure required to displace the water. When the water layer 16 has been decreased to its desired minimum depth (such as between about Om i.e. until the accumulator is substantially free of water, and about 5m or more above the floor/lower wall 15 of the accumulator 12) the accumulator 12 can be considered to be full, and its storage pressure would remain substantially equal to the hydrostatic pressure of the water layer 16. As described herein, having a system that can provide a substantially constant gas pressure while in its charging mode, and conversely while in its discharging mode, may be desirable as it may help the compressors and expanders to be sized and configured to operate within their desired working ranges during a majority of the charging and discharging modes. If gas were to continue to be conveyed into the accumulator 12 while the hydrostatic compensation system is active (i.e. if additional water continued to be displaced from the water layer 16) there may be a risk that gas would escape the accumulator 12, for example by entering into an exposed lower end 64 of the liquid supply conduit 40. Leakage of this nature may decrease efficiency as gas escaping via the water shaft 18 cannot be recaptured during the discharge mode, and may pose a safety risk in some embodiments.

However, in some instances it may be desirable to increase the gas pressure within the accumulator 12 to a storage pressure that is greater than the hydrostatic pressure of the compensation water in the shaft 18. For example, if an accumulator 12 is at a relatively shallow depth underground, for example if the shaft height 50 is only about 200m, then the hydrostatic pressure of the layer of water 16 will be less than if the accumulator 12 were at a depth of 300m or more. Even if the accumulator 12 is a desired depth, it may still be desirable in some circumstances to increase storage pressure of the gas within the accumulator 12 to a level that is higher than the system's hydrostatic pressure. For example, increasing the storage pressure may allow more air to be stored within a given accumulator which may help increase the total amount of energy that can be stored within a given system 10.

To over-pressurize the accumulator 12 that utilizes hydrostatic compensation as described herein the system 10 can be modified in a novel manner to accommodate a two-step charging process and optionally a two-step discharging process. For example, during a first or primary charging mode the system can be operated as described above, with incoming gas displacing a corresponding volume of compensation water from within the accumulator 12. In this mode the unsubmerged volume of the accumulator 12 (e.g. the gaseous volume that is available to store air) is variable and the pressure within the accumulator 12 is held nearly constant a first operating pressure (in this example substantially equal to the compensation water's hydrostatic pressure at the shaft depth 50) because of the hydrostatic compensation displacement. The system can be operating in this manner until the water layer 16 reaches a pre-determined minimum level, or some other suitable target or threshold is achieved. The system can then be switched into a second or secondary charging mode in which the flow of water (or other compensation liquid) into and out of the accumulator 12 is restricted, and preferably is stopped using a suitable compensation isolation apparatus (such as one or more valve, gate, restrictor and/or any other suitable combination of hardware and controllers that can interrupt the compensation liquid flow path between interior of the accumulator 12 and the reservoir 150). That is, the water layer 16 within the accumulator 12 can be essentially sealed and fluidly isolated from the reservoir 150. With nowhere to flow, the compensation liquid in the system can remain stationary as additional gas is forced into the accumulator 12. With the unsubmerged accumulator volume being fixed in this manner the pressure of the gas within the accumulator 12 can continued to increase beyond the first operating pressure until reaching a second maximum operating pressure that can be selected to be the desired final storage pressure for the system.

Similarly, a system configured in this manner may operate with a two-step discharging process, first having a fixed volume discharging mode in which air is withdrawn from the accumulator 12 without allowing the compensation water to flow from the compensation reservoir into the accumulator 12. This can be done until the pressure within the accumulator 12 is substantially the same as the first operating pressure, at which point the second discharging mode can commence. With the accumulator pressure substantially equal to the first operating pressure, fluid communication between the layer of water 16 and the reservoir 150 can be re-established so that as additional gas is drawn from the accumulator 12 a corresponding volume of water flows into the water layer 16 keeping the pressure nearly constant at the first operating pressure during the rest of the discharging process.

The first and second operating pressures can be selected for a given system to be any suitable pressures, but may optionally be selected so that the second operating pressure is between about 105% and about 140%, or more of the first operating pressure, and may be between about 120% and about 130% of the first operating pressure. For example, in some embodiments of the systems 10 the first operating pressure may be between about 40 and about 60 bar, while the second operating pressure may be between about 52 and about 78 bar, or more in some examples.

While operating in this two-step or hybrid charging and discharging mode is preferable for achieving increased energy storage capacity, it need not be done each time the system is in use. In some circumstances the system may be charged in only the first hydrostatically compensated charging mode, then held in storage mode and discharged in only the hydrostatically compensated discharging mode. In other uses the system may be charged to the second operating pressure and only some air may then be required during a discharging phase so the pressure within the accumulator 12 may drop from the second operating pressure but not all the way to the first operating pressure, and the system may then resume its storage mode at a new intermediary pressure that is between the first and second operating pressures. When returned to the charging mode, the pressure may again increase toward the second operating pressure without having utilized the first, hydrostatically compensated charging mode or the hydrostatically compensated discharging mode. Other operating variants are also possible.

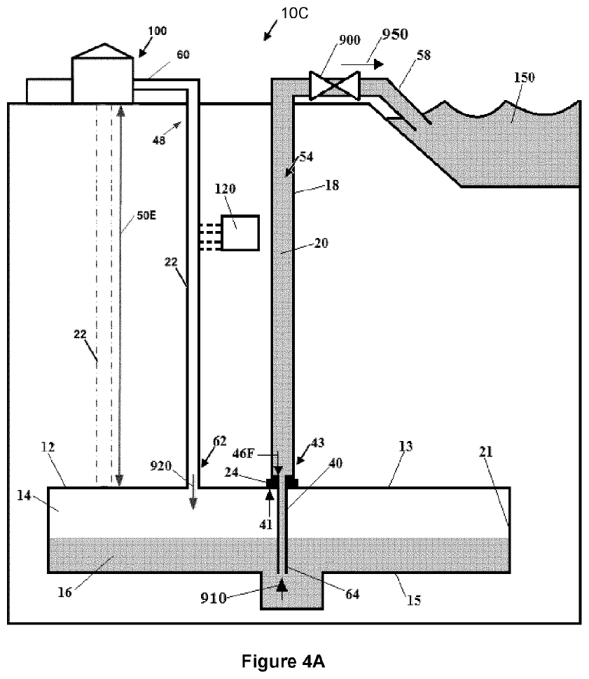

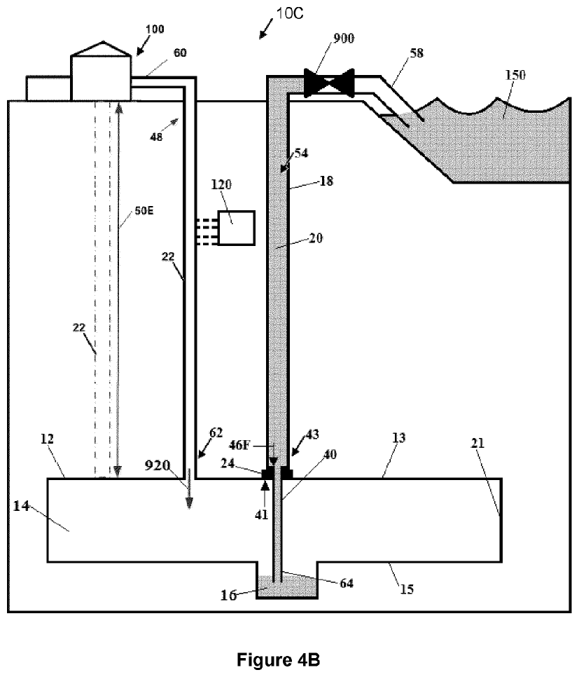

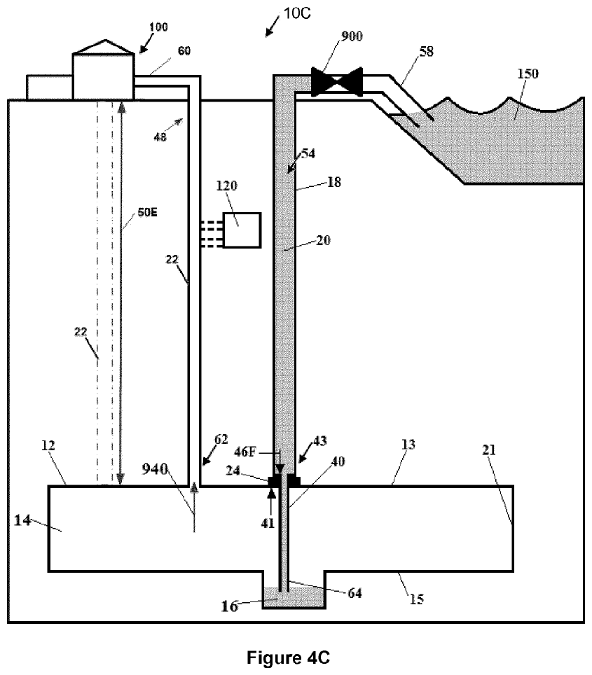

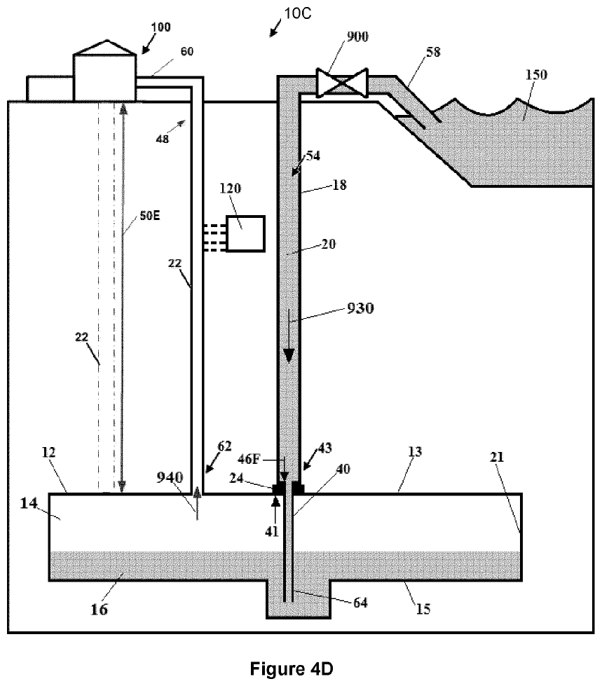

Referring to FIGS. 4A-4D, one example of a hydrostatically compensated compressed gas energy storage system 100 that can be configured to permit over pressurization of the accumulator via a two-stage charging/discharging process is schematically illustrated. In this example the over pressurization of the accumulator 12 (and optionally generally within at least some portions of the compensation liquid flow path) can be may be accomplished using a compensation isolation apparatus that, in this example is schematically illustrated to include a shut-off valve, such as valve 900, that is configured to isolate the accumulator 12 from the water source/sink 150 during pre-determined parts of the operation cycle. The compensation isolation apparatus, (e.g. valve 900 in this example or optionally valve 59), can be configured in an open configuration in which the compensation liquid reservoir 150 is in fluid communication with the layer of compensation liquid 16 within the accumulator 12, whereby when compressed air at the nearly constant first operating pressure is introduced into the layer of compressed air 14 within the accumulator 12 it will displace a corresponding volume of compensation liquid from the layer of compensation liquid 16 out of the accumulator 12 via the liquid flow path thereby maintaining the layer of compressed air 14 at substantially the first operating pressure during the first charging mode. The compensation isolation apparatus is also configurable in the closed configuration in which the liquid flow path is blocked and compensation liquid is not displaced from within the accumulator as compressed air enters the accumulator, which can enable the pressure of the layer of compressed air to increase to a second operating pressure that is greater than the first operating pressure when in use. In the illustrated examples, the compensation liquid may be driven out of the accumulator and along the liquid flow path by the compressed gas during the first charging mode and the systems can be configured such that the compensation liquid flows into the accumulator generally under the force of gravity during the second discharging mode (i.e. the hydrostatic discharge mode), which may reduce or eliminate the need for a separate pump, etc. Alternatively, a pump or other suitable device may be used to help introduce the compensation water back into the accumulator 12 during discharge.

As shown in FIGS. 4A-4D, in the embodiment in system 100, the gas conduit 22 that is provided to convey compressed air between the compressed gas layer 14 and the compressor/expander subsystem 100 system may be arranged such that it is separate and apart from the shaft 18. Further, as shown in FIGS. 4A-4D, a liquid supply conduit 40 may be configured to convey water between the liquid layer 16 and the water 20 in shaft 18. In this particular embodiment, the operation cycle of the system 100 may be considered to have five modes as each of the charging and discharging modes are sub-divided into two segments, plus the storage mode. For example, the system 100 can be described as having: a hydrostatically compensated charging mode (See FIG. 4A); a fixed volume charging mode (See FIG. 4B); a fixed volume discharging mode (See FIG. 4C); a hydrostatically compensated discharging mode (See FIG. 4D), and a storage mode. When operating in the hydrostatically compensated modes (both charging and discharging) the compensation shut-off valve 900 may be left open such that the water 20 in the shaft 18 may flow between the water source/sink 150 and the shaft 18. When operating in the fixed volume modes, (both charging and discharging) the compensation shut-off valve 900 may be closed such that the water 20 in the shaft 18 may not flow between the water source/sink 150 and the shaft 18.

Referring to FIG. 4A, when the system 100 is operated in the hydrostatically compensated charging mode, compressed gas may be directed into the accumulator 12 via the gas conduit 22 (as indicted by the directional arrow 920). As the volume of gas 14 within the accumulator 12 increases, the layer of liquid 16 in the accumulator 12 will be forced out of the accumulator 12, via conduit 40, into the shaft 18 (as indicated by the direction arrow 910). As water is forced from the accumulator 12 into shaft 18, a substantially similar volume of water will be forced from shaft 18 into the water source/sink via water supply/replenishment conduit 58. When in this mode, the pressure within the accumulator 12 will tend to be substantially constant and will be substantially the same as the unmodified hydrostatic pressure of the water 20 at the bottom of the shaft 18 (i.e. the hydrostatic pressure at the accumulator depth 50E, the first operating pressure). The system 100 can continue to operate in this manner until the interface between the liquid layer 16 and air layer 14 within the accumulator 12 reaches a pre-determined lower liquid level threshold which is towards the lower end of cavern wall 21, but above the lower end of water supply conduit 64 (for example, a depth of between 0m and 5m in some examples, to help ensure that the lower end of the of the water supply conduit 64 remains submerged to limit gas leakage). This manner of operation is similar to charging the other hydrostatically compensated, but not over pressurized, systems 10 described herein (e.g. the embodiment shown in FIG. 1).

Referring to FIG. 4B, to continue to charge the accumulator 12 with more compressed gas after the liquid layer reaches its pre-determined lower liquid level threshold, and in turn increase the amount of total energy which can be stored in accumulator 12, the system 10C can enter what is considered the second, fixed volume charging mode. In this mode, the compensation shut-off valve 900 may be closed to isolate the source/sink 150 from the water 20 in the shaft 18 and accumulator 12. During this portion of the charging cycle, as compressed gas is directed into the accumulator 12 via the gas conduit 22 (as indicted by the directional arrow 920) the accumulator pressure may continue to increase until the maximum operating pressure is reached. This in turn will pressurize the water 20 in the shaft 18 and cause the pressure 46F to exceed the standard hydrostatic pressure at depth 50E. The pressure 46F will generally stay matched with the gas pressure within the accumulator 12 in this example. As water is generally incompressible, the interface between the liquid layer 16 and air layer 14 within the accumulator 12 will remain substantially constant during the fixed volume charging mode.

At any point during the charging cycle the system 100 can be converted to its storage mode, in which the flow of gas is stopped and the pressurized gas is stored in the accumulator 12 until a discharge mode (or subsequent charge mode) is called for.

When the system 100 is eventually operated in its discharge mode, it may begin by operating in the fixed volume discharge mode (e.g. so long as the last charging mode was the fixed volume charging mode). Referring, for example, to FIG. 4C, during the fixed volume discharging mode the compensation shut-off valve 900 may remain closed to keep the source/sink 150 isolated from water 20 in the shaft 18 and accumulator 12 while gas is removed from the accumulator. During this portion of the discharge cycle, as compressed gas is transferred from the accumulator 12 and into the compressor/expander subsystem 120 for expansion (as indicted by the directional arrow 940), the accumulator pressure decreases from the maximum operating accumulator pressure to the unaltered hydrostatic pressure of the water 20 in the shaft 18. As water is generally incompressible, the interface between the liquid layer 16 and air layer 14 within the accumulator 12 will remain substantially constant during the fixed volume discharging mode Once the gas pressure in accumulator 12 reaches the hydrostatic pressure, the compensation shut-off valve 900 may be opened allowing additional water to flow into the shaft 18 as gas is removed from the accumulator and beginning the hydrostatically compensated discharging mode.

Once the compensation shut-off valve 900 has been opened during discharging, the system 100 may be considered to be in its hydrostatically compensated discharge mode and may operate in a manner similar to the other systems 10 described herein (e.g. the embodiment shown in FIG. 1). For example, referring to FIG. 4D, during the hydrostatically compensated discharging mode, compressed gas may be transferred from the accumulator 12 and into the compressor/expander subsystem 120 for expansion (as indicted by the directional arrow 940), such that the amount of gas 14 in the accumulator 12 decreases. As the amount of gas decreases, water from within the shaft 18 will flow into the accumulator 12. To maintain the same volume of water within the shaft 18 and the same pressure, water from the source/sink 150 may flow through the open compensation shut-off valve 900 and into the shaft 18 (as indicted by the directional arrow 930). This can help ensure the shaft 18 remains substantially full and can help ensure that the force 46F remains substantially balanced with the internal accumulator force 41.

A complete operation of the cycle of the embodiment shown in FIGS. 4A-D can involve, in some examples, i) starting in the storage mode with little to no gas in accumulator 12, ii) entering the hydrostatically compensated charging mode and operating until the pre-determined lower liquid level threshold is reached, iii) entering the fixed volume charging mode and operating until the maximum operating pressure is reached, iv) entering a storage mode until energy is required, v) entering the fixed volume discharging mode until the hydrostatic pressure is reached, vi) entering the hydrostatically compensated discharging mode until there is little to no gas left in accumulator 12, vi) entering the storage mode until surplus/low value energy is available for charging.

Depending on the availability and demand for energy throughout the day, the system may not always perform a complete operation cycle. For example, the system may not enter fixed volume operation during a partial cycle by entering the storage mode after step ii), skipping steps iii) and v), then continuing with step vi).

What has been described above has been intended to be illustrative of the invention and non-limiting and it will be understood by persons skilled in the art that other variants and modifications may be made without departing from the scope of the invention as defined in the claims appended hereto.

1. A method of operating a hydrostatically compensated compressed air energy storage system, the system comprising an accumulator having an accumulator interior for containing a layer of compressed air above a layer of compensation liquid, a compensation liquid reservoir spaced apart from the accumulator and connectable in fluid communication with the accumulator via a compensation liquid flow path, a compensation isolation apparatus disposed in the compensation liquid flow path and a gas compressor/expander subsystem in fluid communication with the accumulator interior via an air flow path, wherein the method comprises:
a) compressing air using the gas compressor/expander subsystem;
b) operating the system in a first charging mode comprising conveying the compressed air at a nearly constant first operating pressure into the accumulator while the compensation isolation apparatus is in an open configuration in which the compensation liquid reservoir is in fluid communication with the layer of compensation liquid within the accumulator, whereby compressed air at the nearly constant first operating pressure is introduced into the layer of compressed air within the accumulator which displaces a corresponding volume of compensation liquid from the layer of compensation liquid out of the accumulator via the liquid flow path thereby maintaining the layer of compressed air at substantially the first operating pressure during the first charging mode;
c) reconfiguring the compensation isolation apparatus into a closed configuration in which fluid communication between the compensation liquid reservoir and the layer of compensation liquid is interrupted;
d) operating the system in a second charging mode comprising conveying additional compressed air into the accumulator while the compensation isolation apparatus is in the closed configuration whereby compensation liquid is not displaced from within the accumulator as compressed air enters the accumulator and the pressure of the layer of compressed air increases to a second operating pressure that is greater than the first operating pressure.

2. The method of claim 1, further comprising operating the system in the first charging mode until the layer of compensation liquid within the accumulator has reached a pre-determined minimum operating height above the lower end of the accumulator.

3. The method of claim 2, wherein the pre-determined minimum operating height is between about Om and about 5m above the lower end of the accumulator.

4. The method of claim 1, further comprising operating the system in the first charging mode until the accumulator is substantially free of compensation liquid and then reconfiguring the compensation isolation apparatus into the closed configuration.

5. The method of claim 1, wherein the liquid flow path comprises a liquid supply conduit having a lower end that remains submerged within the layer of compensation liquid within the accumulator while the system is operated in the first charging mode.

6. The method of claim 5, wherein the lower end of the liquid supply conduit remains submerged within the layer of compensation liquid within the accumulator while the system is operated in the second charging mode.

7. The method of claim 1, wherein the accumulator is positioned underground at an accumulator depth and wherein the first operating pressure is substantially equal to the hydrostatic pressure at the accumulator depth when the compensation isolation apparatus is in the open configuration.

8. The method of claim 1, further comprising configuring the system in a storage mode in which the air flow path is interrupted and the compressed air is retained within the accumulator at at least one of the first operating pressure, the second operating pressure, and a pressure in between the first and second operating pressures.

9. The method of claim 8, wherein the system is configured in the storage mode after the second charging mode and the compressed air is retained within the accumulator at the second operating pressure.

10. The method of claim 9, further comprising:
a) operating the system in a first discharging mode comprising extracting compressed air from the accumulator via the air flow path while the compensation isolation apparatus is in the closed configuration whereby pressure within the accumulator decreases as the air is extracted and the extracted air drives an expander in the gas compressor/expander subsystem;
b) reconfiguring the compensation isolation apparatus into the open configuration when the pressure within the accumulator reaches the first operating pressure, thereby re-establishing fluid communication between the accumulator and the compensation liquid reservoir;
c) operating the system in a second discharging mode while the compensation isolation apparatus is in the open configuration such that a corresponding volume of compensation liquid flows into the layer of compensation liquid within the accumulator as air is extracted from the accumulator thereby maintaining the interior of the accumulator at the nearly constant first operating pressure during the second discharging mode.

11. The method of claim 10, further comprising continuing the second discharging mode until the layer of compensation liquid within the accumulator has reached a pre-determined maximum height.

12. The method of claim 11, further comprising continuing the second discharging mode until the accumulator is substantially filled with compensation liquid.

13. The method of claim 1, wherein the second operating pressure is between about 120% and about 130% of the first operating pressure.

14. The method of claim 1, wherein the compensation liquid is driven along the liquid flow path by the compressed gas during the first charging mode.

15. The method of claim 14, wherein the compensation liquid flows into the accumulator under the force of gravity during the second discharging mode.

16. A hydrostatically compensated compressed air energy storage system comprising:
a) an accumulator disposed underground and comprising an interior for containing a layer of compressed air above a layer of compensation liquid;
b) a compressor/expander subsystem in fluid communication with the accumulator interior via an air flow path and configured to selectably convey compressed air into the accumulator and to extract air from the accumulator;
c) a compensation liquid reservoir spaced apart from the accumulator and a compensation liquid flow path extending between the compensation liquid reservoir and the accumulator; and
d) a compensation isolation apparatus provided in the compensation liquid flow path and configurable in an open configuration in which the compensation liquid reservoir is in fluid communication with the accumulator and closed configuration in which fluid communication between the compensation liquid reservoir and the accumulator is interrupted;
the system being operable in at least:
i) a first charging mode in which the compensation isolation apparatus is in the open configuration and the gas compressor/expander subsystem is configured to covey compressed air at a nearly constant first operating pressure into the layer of compressed air within the accumulator which then displaces a corresponding volume of compensation liquid from the layer of compensation liquid within the accumulator out of the accumulator via the compensation liquid flow path thereby maintaining the layer of compressed air at substantially the first operating pressure during the first charging mode; and
ii) a second charging mode in which the compensation isolation apparatus is in the closed configuration and the gas compressor/expander subsystem is configured to covey additional compressed air into the accumulator while compensation liquid does not exit the accumulator via the liquid flow path whereby the pressure within the accumulator increases from the first operating pressure to a higher, second operating pressure.

17. The system of claim 16, wherein the system is also operable in a storage mode in which the flow of air through the air flow path is inhibited and the layer of compensation liquid and the layer of compressed gas are stored within the accumulator.

18. The system of claim 16, wherein the system is also operable in:
iii) a first discharging mode in which the compensation isolation apparatus is in the closed configuration and the gas compressor/expander subsystem is configured to extract compressed air from the accumulator while compensation liquid does not enter the accumulator via the liquid flow path whereby the pressure within the accumulator decreases from the second operating pressure to the first operating pressure; and
iv) a second discharging mode in which the compensation isolation apparatus is in the open configuration and the gas compressor/expander subsystem is configured to extract additional compressed air from within the accumulator which then enables a corresponding volume of compensation liquid to enter the accumulator thereby maintaining the pressure within the accumulator at the nearly constant first operating pressure during the second discharging mode.

19. The system of claim 16, wherein the liquid flow path comprises liquid supply conduit having a lower end that remains submerged within the layer of compensation liquid while the system is operated in the first charging mode and while the system is operated in the second charging mode.

20. The method of claim 16, wherein the accumulator is positioned underground at an accumulator depth and wherein the first operating pressure is substantially equal to the hydrostatic pressure of the layer of compensation liquid at the accumulator depth when the compensation isolation apparatus is in the open configuration.
